(19) United States
(12) Patent Application Publication
(10) Pub. No.: US 2025/0141692 A1
(43) Pub. Date: May 1, 2025

(54) SYSTEM AND METHOD FOR MEASURING, SCORING AND AUTHENTICATING ARTIFICIAL INTELLIGENCE PRODUCED CONTENTS

(71) Applicant: ARRIS Enterprises LLC, Horsham, PA (US)

(72) Inventors: James Jian NI, Escondido, CA (US); Xin QIU, San Deigo, CA (US)

(73) Assignee: ARRIS Enterprises LLC, Horsham, PA (US)

(21) Appl. No.: 18/930,909

(22) Filed: Oct. 29, 2024

Related U.S. Application Data
(60) Provisional application No. 63/546,387, filed on Oct. 30, 2023.

(51) Int. Cl. H04L 9/32

(52) U.S. Cl. CPC H04L 9/3247

(57) ABSTRACT

A system and method for generating content from an artificial intelligence (AI) system is disclosed. In one embodiment, the system is trained by one or more training instructors using training content having one or more training content pieces, and the method comprises accepting first information associating training content with training content attributes; accepting second information associating the AI system with training instructor profiles; generating the AI generated content in response to an AI content generation request from a user; and providing the AI generated content, the first information and the second information to the user.

### CROSS-REFERENCE TO RELATED APPLICATIONS

This application claims benefit of U.S. Provisional Patent Application No. 63/546,387, entitled “SYSTEM AND METHOD FOR MEASURING, SCORING AND AUTHENTICATING ARTIFICIAL INTELLIGENCE PRODUCED CONTENTS,” by James Jian Ni and Xin Qiu, filed Nov. 7, 2023, which application is hereby incorporated by reference herein.

### BACKGROUND

### 1. Field

The present disclosure relates to systems and methods for authenticating data and data sources.

### 2. Description of the Related Art

Artificial intelligence (AI) is a technology that uses computer implemented algorithms and databases to perform a variety of tasks. One such task is the generation of content, including media content, software, or other items. Such AI produced content will soon overwhelm the content produced by human beings.

AI is achieved by intelligence acquisition. AI can acquire intelligence via simple rule based paradigms in which a set of rules is “taught” to the AI system. AI can also acquire intelligence via a machine learning based paradigm. In this paradigm, the AI system is presented with information that is used to find and match patterns, and to use such patterns in generating content and producing information. Such learning generally requires a great deal of “training” data to examine. Machine learning is used in conjunction with search and optimization techniques, constraint satisfaction, logical and probabilistic reasoning, and control theory. Ultimately, the quality of the product of AI is the quality and selection of the training data and how that training data is properly curated to assure that the data is accurate, relevant, and of high quality.

AI systems can be trained by human produced contents, AI produced contents, or a mix of human and AI produced contents. Further, the instructions used in such training can be good will instructions (e.g., reliable instructions intended to produce good results), general instructions (e.g., instructions of general pedigree), or bad will instructions (e.g., unreliable instructions or those intended to produce false results).

As a consequence, AI produced contents may be of varying levels of trustworthiness. There is therefore a need to label, measure, and authenticate the nature of such contents. For example, the recipient of such AI-generated content may wish to know to what extent the AI content was produced purely by humans, human-approved AI operations or content, or human-not-aware AI operations. The recipient of such AI-generated content may also wish to know whether the AI is produced from (e.g., trained using) purely human content, mixed human, and AI content or purely AI content. The user may also wish to know whether all of the content used to train the AI are authenticated as to source, approved, and measured. Accordingly, there is a need for a system and method for providing measurable, trackable, authenticatable, information regarding the quality and source of the AI generated content, and to provide authenticating mechanisms to assure that such information is not tampered with.

### SUMMARY

To address the requirements described above, this document discloses a system and method for generating AI generated content from an AI system, trained by one or more training instructors using training content having one or more training content pieces. In one embodiment, the method comprises accepting first information associating training content with training content attributes; accepting second information associating the AI system with training instructor profiles; generating the AI generated content in response to an AI content generation request from a user; and providing the AI generated content, the first information and the second information to the user.

Another embodiment is evidenced by an apparatus having a processor and a communicatively coupled memory storing processor instructions for performing the foregoing operations. Still another embodiment is evidenced by an apparatus for generating content from an AI system, trained by one or more training instructors using training content having one or more training content pieces, comprising: a training input classification module, for accepting first information associating a piece of training content with training content attributes according to a content classification profile; training instructor profiles having second information associating the AI system with training instructor attributes; an AI system core, for generating the content in response to an AI content generation request from a user; and an AI content evaluation module, for generating an evaluation of the content according to a content evaluation profile having the first information and the second information and for providing the generated content and the evaluation to the user.

The features, functions, and advantages that have been discussed can be achieved independently in various embodiments of the present invention or may be combined in yet other embodiments, further details of which can be seen with reference to the following description and drawings.

### BRIEF DESCRIPTION OF THE DRAWINGS

Referring now to the drawings in which like reference numbers represent corresponding parts throughout:

FIG. 1 is a diagram depicting the development and use of a typical AI system;

FIG. 2 is a diagram illustrating the flow of AI machine learning;

FIGS. 3A and 3B are diagrams illustrating an improved AI system;

FIG. 4 is a diagram depicting exemplary operations performed by the improved AI system; and

FIG. 5 is a diagram depicting an exemplary computer system that could be used to implement processing elements of the AI system.

### DESCRIPTION

In the following description, reference is made to the accompanying drawings which form a part hereof, and which is shown, by way of illustration, several embodiments. It is understood that other embodiments may be utilized and structural changes may be made without departing from the scope of the present disclosure.

### Overview

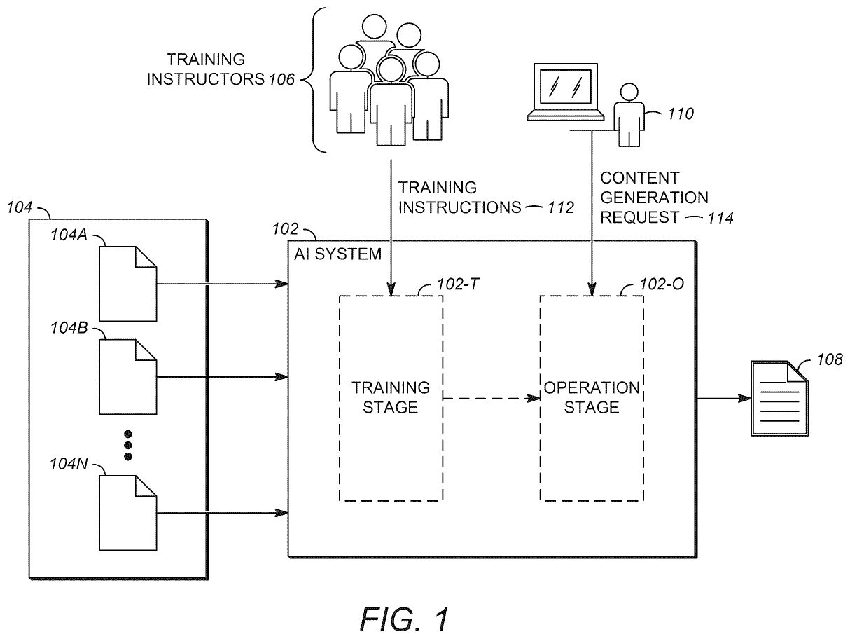

FIG. 1 is a diagram depicting the training and use of a typical AI system 102. Training inputs 104 (e.g., training inputs 104A-104N) and training instructions 112 are selected and modified as necessary by training instructors 106 and provided to the AI system 102, and the AI system 102 in the training stage 102-T uses this data to train the algorithms and databases used by the AI system 102. A user 110 provides a content generation request 114, and the AI system 102 operating in the operation stage 102-0, generates AI produced content 108. The AI produced content 108 may be reviewed (by instructors 106 or other entities) to determine whether the AI produced output 108 meets the expected or desired results. If the AI produced output 108 does not meet expected or desired results, the training instructors generate further or different training instructions 112 and/or training inputs 104 to further or retrain the AI system 102. This training process implements AI machine learning is repeated until the AI system 102 generates AI produced content 108 that is acceptable to the training instructors 106.

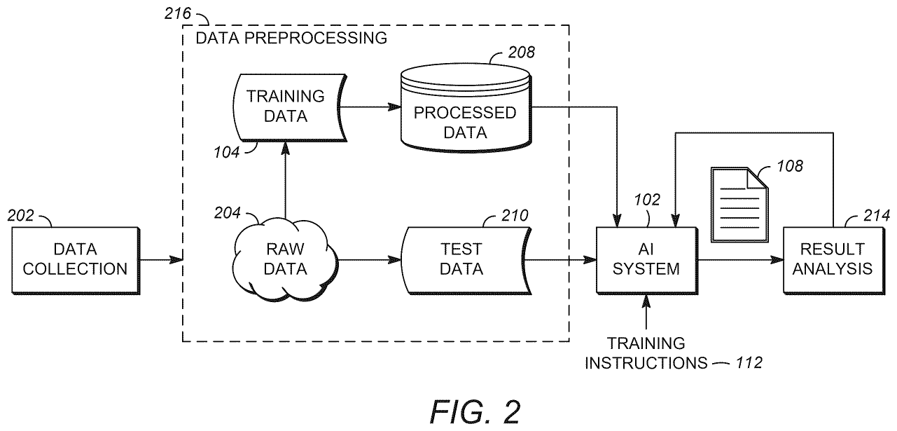

FIG. 2 is a diagram further illustrating exemplary flow of the AI training process.

Data Collection and Data Preprocessing 216: In this stage, non-structured raw data 204 is collected, as shown in block 202. Such data may include images, texts, and aural data such as voice inputs. Raw data 204 includes noise, can be inconsistent or repetitive, and so is not suitable for application to AI algorithms.

To ensure high quality, reliability, accuracy, and performance of the AI system 102, data preprocessing 216 is performed by the training instructors 106 to improve quality of data. In this stage, data analysis and organization are conducted (typically by human training instructors 106) with professionalism and insight, including modification of data errors, elimination of overlapping data, deletion of inconsistent data, and coordination of data conflicts. This may include filling or deleting missing values, selecting, or deleting data properties, combining existing data properties, and converting raw data 204 into a designated type as needed. The result is preprocessed training data 208. It is important that the proper training data 104 and training instructions 112 be used to train the AI system 102, and hence, that the human(s) involved in this process (e.g., the training instructors 106) be trusted. The processed training data 208 is then applied to the AI system in the training mode 102-T.

Test data 210 may also be derived from the raw data 204 by training instructors 106 and used to test the AI system while in the operational mode 102-0. As is the case with training data, test data 210 is processed 208 and analyzed before application to the AI system 102, including exploring standardized data patterns, data mapping, and extracting data based on exploration and inference. The test data 210 is then applied to the AI system in the operational mode 102-0, and the resulting AI produced content 108 is analyzed by the training instructors 106 to assure accuracy and responsiveness (e.g., that the AI produced content 108 is responsive to the parameters defining the content generation request 114), as shown in block 214. This analysis is feedback to modify the AI model 212, collect further data or perform additional preprocessing of the collected data 204.

The AI system 102 can then be used in the operational mode 102-O to generate AI produced content 108 in response to content generation requests 114. Training instructors 106 can monitor such AI produced content 108 and content generation requests 114 to assure accuracy and responsiveness, and further train or re-train the AI system 102 as required.

The accuracy and usefulness of an AI system 102 is therefore largely dependent on the quality of the processed training data 208 used to train it, and that depends on the quality of the human training instructors 106 involved in selecting the raw data 204, preprocessing that raw data 204 and managing the training process. Because raw data 204 needs human processing and inspection to secure data quality for sophisticated AI learning, human errors are inevitable. Damaged and incomplete data, as well as differences from raw data 204, may lead to unexpected outputs from the AI system 102. Hence, in the course of establishing the models used by the AI system 102, the processed training data 206 must be monitored to verify that the AI produced content 108 is responsive to content generation requests 114.

Although services for collecting and processing data to be applied to train an AI system 102 are available, the reliability of such data has remained problematic. The source of raw data 204 may be unreliable or such raw data 204 may be offered for malicious purposes. Accordingly, the raw data 204 itself must be analyzed and the sources of such data must be identified, so that a traceable learning data collection environment can be established. Further, the training process is opaque to users, rendering the AI system 100 very much a black box.

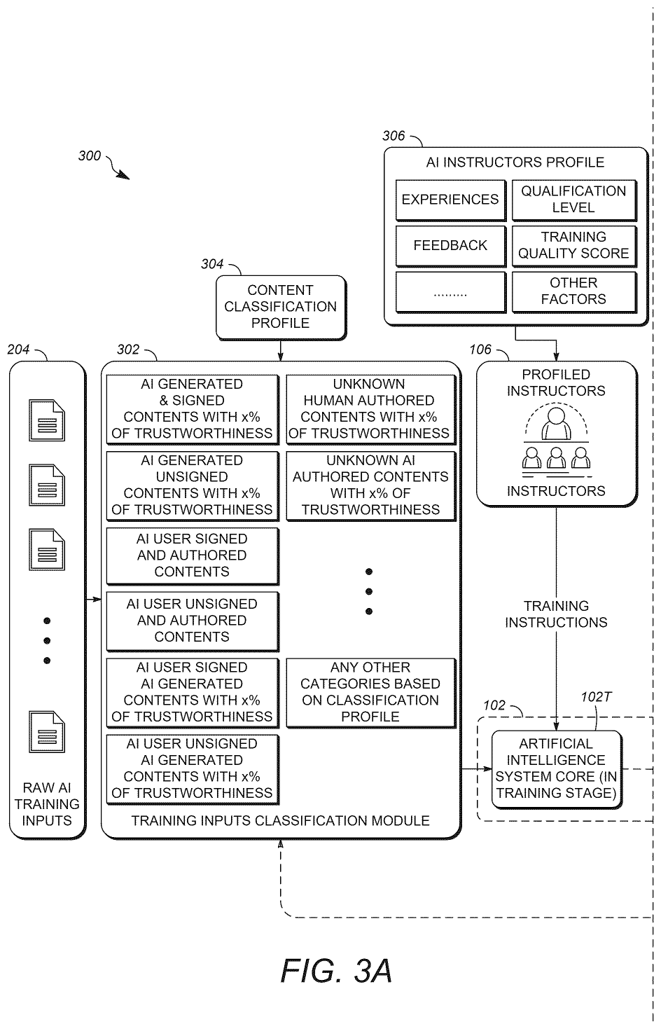

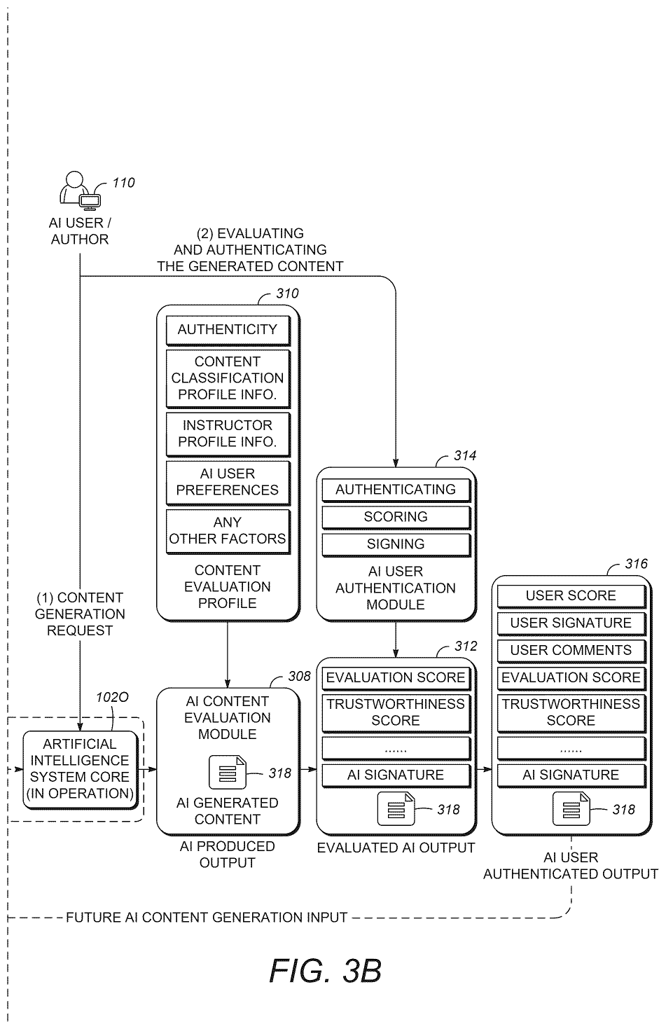

FIGS. 3A and 3B are diagrams illustrating an improved AI system 300 that enables scoring or other quantitative values to be associated with AI produced data. These quantitative values provide information regarding the AI generated data that allows the consumer of the data to determine the quality and trustworthiness of the AI generated data.

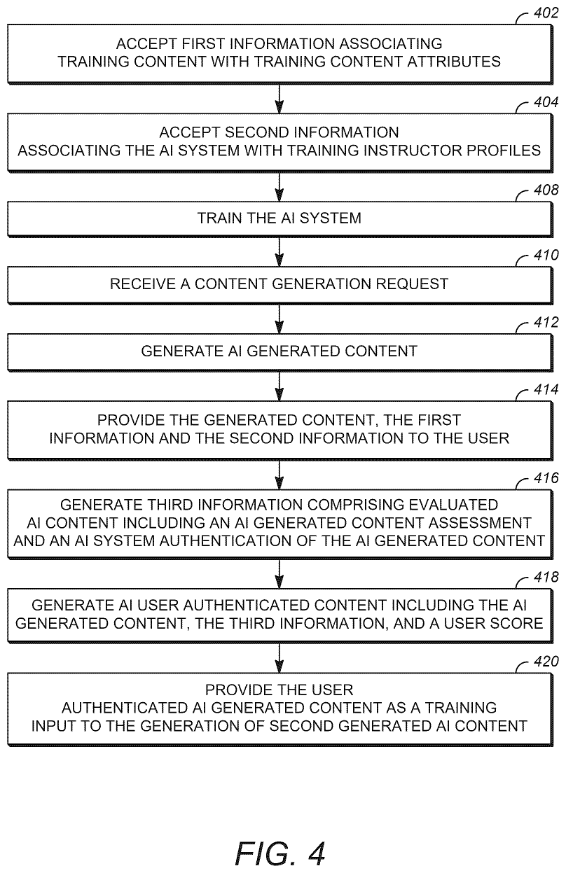

FIG. 4 presents a diagram illustrating exemplary operations that can be used to generate AI produced data along with authenticated information regarding the production of the AI data. FIGS. 4A and 4B will be discussed in conjunction with FIGS. 3A and 3B.

Turning to FIG. 4, the improved AI system 300 accepts first information associating one or more pieces of processed data 208 (hereinafter alternatively referred to as training content 208) with training content attributes, as shown in block 402.

### Information Associating Training Content With Training Content Attributes

In one embodiment, this first information associating training content 208 with training content attributes is generated by a training inputs classification module (TICM) 302 using the raw AI training inputs 104 as determined by the content classification profile 304 illustrated in FIGS. 3A and 3B.

The TICM 302 accepts raw AI training data input data 204 and classifies the raw AI training data input 204 according to a content classification profile 304. The content classification profile 304 defines the training content attributes that will be used to classify and score the raw AI training input data 204, as well as the rules by which each piece of training content 208 will be classified.

In one embodiment, the first information defines training content attributes that include one or more of the following:

An author approval score, provided by the author of the training content 208: The approval score indicates a measure of the extent to which the author of the training content 208 approves the use of the data as training content 208.

A contributor allocation score: The contributor allocation score indicates the proportion of contributor content used in the generation of the training content 208. For example, a contributor allocation score of 70% may indicate that approximately 30% of the training content 208 was original to the author of the training content 210, with the other 70% coming from other contributors. In one embodiment, the contributor allocation score includes at least one of human authored contributor content score (for example, representing the percentage of the training content 208 that is human authored), approved AI authored contributor content score (representing the percentage of the training content 208 that is authored by an approved AI source), and unapproved AI authored contributor training content score (representing the percentage of the training content 208 that is authored by an unapproved AI source). All of the foregoing contributor allocation scores may be expressed, for example, as a percentage of the total training content 208. For example, a particular raw AI training input may have a contributor allocation score of 50% human authored contributor content, 40% approved (by the instructors 106) AI authored contributor content, 5% unapproved AI authored contributor content, and 5% mixed approved AI authored content, unapproved AI authored content, and human authored contributor content.

An AI system signature: This is a digital signature that represents the specific AI system 300 with one or more authenticated instructor profiles.

An indication of whether the training content 104 is digitally signed by the author of the training content 104: In one embodiment, the indication is a binary value in which one state indicates that the training content is digitally signed and the other state indicates that the training content is not digitally signed by the author of the training content. Digitally signed training content is typically deemed more reliable, particularly by an author noted for data accuracy and reliability.

A signature of the author of the training content 104: Any element of the first information may be signed by the author of the training content 104. For example, the training content 104 itself may be hashed and signed by the author of the training content and included in the first information. Also, the author approval score and contributor allocation score may also be signed by the author.

As indicated in FIG. 3A, the first information the raw AI training content 104 may also be classified into groups by trustworthiness, whether the AI training content is signed, and the author (AI or human) as follows:
AI generated and signed training content 208 with A % trustworthiness;
AI generated and unsigned training content 208 with B % of trustworthiness;
AI user signed and authored training content 208;
AI user authored training content 208 that is unsigned,
AI user signed AI generated training content 208 with C % of trustworthiness;
AI user unsigned AI generated training content 208 with D % of trustworthiness;
training content 208 generated by an unknown human with E % of trustworthiness;
training content 208 generated by unknown AI with F % of trustworthiness;
   or any similar classifications. This information can be obtained from metadata provided with the training content 208 or by human instructors 106 that examine the training content 208 and categorize and score the training content 208.

Returning to FIG. 4, the improved AI system 300 also accepts second information associating the AI system 102 with training instructor profiles 306 and individual training instructor profiles, as shown in blocks 404 and 406.

### Information Associating the AI System With Aggregate and Individual Training Instructor Profiles

The training instructors 106 have individual training instructor profiles which indicate their experience, qualification level, training quality, and feedback from AI users 110, as well as other factors. Such information may include one or more of training instructor certification information (e.g., professional certifications, academic qualifications), instructor experience and/or skill scores, instructor professional scores in the particular subject area of the generated content (for example, instructors may be given standardized examinations in the subject are of interest), and instructor assessment scores based on reviews from one or more other AI system 300 users.

Aggregate training instructor profiles may be used in addition to or instead of individual instructor profiles. Such aggregate profiles describe the demographics of two or more of the profiled training instructors 106 (e.g., describing what percentage of the training instructors 106 are certified or have particular educational or experience qualifications). For example, the demographics may be expressed as a distribution of the particular educational or experience qualifications. For example, the individual instructors may be classified as those who have completed certified training course, or have obtained a particular educational status. In this case, the aggregate training instructor profile may present, for example, a graph of how many instructors in the group of profiled training instructors 106 have completed each training course or achieved each educational status. Such aggregate training instructor profiles allows a user 100 obtaining AI generated output 308 generated by the AI system 300 to determine whether the group of training instructors 106, as a whole, have the requisite experience in the subject matter of the AI generated output 308.

Similarly, the aggregate training instructor profiles may include information describing experience or skill scores for two or more of the training instructors in the subject of the training content. This presents, for example, the distribution of skill scores (obtained through examination, for example) of the group of profiled instructors. Aggregate training instructor profiles may also include a distribution of review scores of the training instructors, with each review score based on an assessment of another person (other than the subject of the review) of the trustworthiness of the generated content and approval of the generated content.

Returning to FIG. 4, the or more profiled instructors 106 train the AI system 300 by generating training instructions that are used by the AI system core in the training stage 102-T to operate on the training content 104. This is illustrated in block 408.

After the AI system 300 is trained, the AI system 300 receives a content generation request from an AI user 110, operating in the operational stage (rather than the training stage) 102-0. The AI system 300 then generates the requested AI content, 318 as shown in block 412.

In block 414, the generated content, first information (regarding the training content), and second information (regarding instructor profiles) is provided to the user 110.

In block 416, the AI user authentication module 314 generates third information (evaluated AI output 312) for the AI generated content 318 using the first information (regarding training content) and the second information (regarding instructor demographics) as well as optional AI user 110 preferences. The third information comprises an assessment and authentication of the AI generated content 318. The assessment may include one or more scores, which may include, for example, an evaluation score (evaluating the usefulness of the AI generated content) and a trustworthiness score (evaluating the trustworthiness of the generated AI content). In one embodiment, this is performed by the AI content evaluation module 308 illustrated in FIG. 3B using the AI content evaluation profile 310. In evaluating the AI generated content, the AI content evaluation module 308 uses information from the content classification profile 304 and the AI instructor profile 306. Preferences of the AI user 110 (for example, which factors the AI user 110 believes to be most important in evaluating the content or how such factors should be weighted) may also be input to the AI content evaluation module. In another embodiment, the scores are generated by the AI user 110, using the first information and second information. In still another embodiment, the scores are generated by the AI content evaluation module 308, but may be modified by the AI user 110. The evaluation score and trustworthiness score, as well as the AI generated content 318 may be signed by the AI system 300, specifically the AI content evaluation module 308.

Referring now to block 418 of FIG. 4, AI user authenticated output 316 is generated. In one embodiment, this includes a user score, a user signature, optional comments, the evaluation score from the evaluated AI output 312, and the AI system signature from the evaluated AI output 312.

This may be accomplished by the AI user 110 using the AI user authentication module 308 to authenticate and sign the AI produced output and provide information describing that AI user's assessment of the trustworthiness of the generated content. This may be evidenced by an evaluation score and a trustworthiness score generated by the AI content evaluation module 308, which may be modified by the AI user 110 as they deem appropriate. The AI user 110 may also use the first information and second information in this assessment to evaluate the AI generated content 318 and may sign the AI generated content 318 and or score(s). This information is included in the AI User Authenticated Output 318, which includes the AI generated content, the evaluation and trustworthiness scores contributed by the AI Content Evaluation Module 308 and optionally modified by the AI user 110. The AI user authenticated output 316 may also include a score from the AI user 110 regarding that AI user's personal evaluation of the AI generated content, the AI user's signature, and AI user's comments.

Finally, referring to block 420 of FIG. 4, the AI user authenticated output 316 is provided as training input for the generation of second generated AI content.

### Hardware Environment

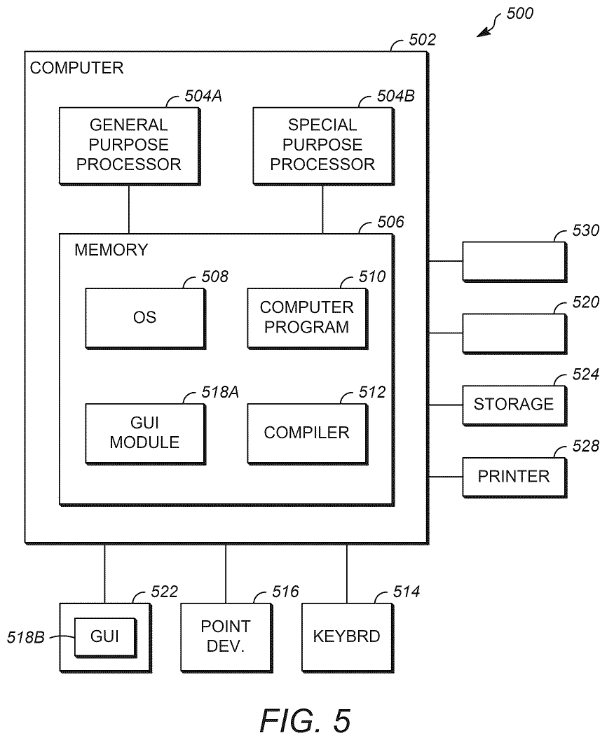

FIG. 5 illustrates an exemplary computer system 800 that could be used to implement processing elements of the above disclosure, including the any of the processors computing the processing threads. The computer 502 comprises one or more processors (CPU, GPU etc.) 504 and a memory, such as random access memory (RAM) 506. The computer 502 is operatively coupled to a display 922, which presents images such as windows to the user on a graphical user interface 918B. The computer 902 may be coupled to other devices, such as a keyboard 914, a mouse device 916, a printer 928, etc. Of course, those skilled in the art will recognize that any combination of the above components, or any number of different components, peripherals, and other devices, may be used with the computer 902.

Generally, the computer 902 operates under control of an operating system 908 stored in the memory 906, and interfaces with the user to accept inputs and commands and to present results through a graphical user interface (GUI) module 518A. Although the GUI module 518B is depicted as a separate module, the instructions performing the GUI functions can be resident or distributed in the operating system 508, the computer program 510, or implemented with special purpose memory and processors. The computer 502 also implements a compiler 512 which allows an application program 510 written in a programming language such as Python, C/C++, Java, or other language to be translated into processor 504 readable code. After completion, the application 510 accesses and manipulates data stored in the memory 506 of the computer 502 using the relationships and logic that was generated using the compiler 512. The computer 502 also optionally comprises an external communication device such as a modem, satellite link, Ethernet card, or other device for communicating with other computers.

In one embodiment, instructions implementing the operating system 508, the computer program 510, and the compiler 512 are tangibly embodied in a computer-readable medium, e.g., data storage device 520, which could include one or more fixed or removable data storage devices, such as a zip drive, floppy disc drive 524, hard drive, CD-ROM drive, tape drive, etc. Further, the operating system 508 and the computer program 510 are comprised of instructions which, when read and executed by the computer 502, causes the computer 502 to perform the operations herein described. Computer program 510 and/or operating instructions may also be tangibly embodied in memory 506 and/or data communications devices 530, thereby making a computer program product or article of manufacture. As such, the terms “article of manufacture,” “program storage device” and “computer program product” as used herein are intended to encompass a computer program accessible from any computer readable device or media.

Those skilled in the art will recognize many modifications that may be made to this configuration without departing from the scope of the present disclosure. For example, those skilled in the art will recognize that any combination of the above components, or any number of different components, peripherals, and other devices, may be used.

### Conclusion

This concludes the description of the preferred embodiments of the present disclosure.

In summary, this document discloses a system and method for generating artificial intelligence (AI) generated content from an AI system, trained by one or more training instructors using training content having one or more training content pieces. In one embodiment, the method comprises accepting first information associating training content with training content attributes; accepting second information associating the AI system with training instructor profiles; generating the AI generated content in response to an AI content generation request from a user; and providing the AI generated content, the first information and the second information to the user.

Implementations may include one or more of the following features.

Any of the above methods, wherein: the first information and the second information is signed by the AI system.

Any of the above methods, wherein the method further comprises: generating third information, the third information comprising evaluated AI generated content including an AI generated content assessment and an AI system authentication of the AI generated content; and generating user authenticated AI generated content including the AI generated content, the third information, and a user score.

Any of the above methods, wherein: the assessment includes an evaluation score and a trustworthiness score signed by the AI system.

Any of the above methods, wherein: the user authenticated AI generated content is signed by the user.

Any of the above methods, wherein: the user authenticated AI generated content is provided as a training input to the generation of second generated AI content.

Any of the above methods, wherein: the first information comprises one of more of: a binary indication of whether the training content is digitally signed by the author of the training content; an author approval score, provided by the author of the training content, the author approval score indicating a measure of the approval of the training content by the author of the training content; a contributor allocation score, the contributor allocation score indicating a proportion of contributor content used in the generation of the training content; and an AI signature with an authenticated instructor profile.

Any of the above methods, wherein: the first information includes a signature of an author of the training content.

Any of the above methods, wherein: the contributor allocation score includes at least one of: human authored contributor content; approved AI authored contributor content; unapproved AI authored contributor content; and mixed approved AI, unapproved AI, and human authored contributor content.

Any of the above methods, wherein: the training instructor profiles comprise aggregate training instructor profiles comprising at least one of: a distribution of the training of two or more of the training instructors; a distribution of experience or skill scores of two or more of the training instructors in a subject of the training content; a distribution of review scores of the training instructors, each review score based on an assessment by another of the trustworthiness of the generated content and approval of the generated content.

Any of the above methods, wherein: training instructor profiles comprise individual profiles of the one or more instructors, which comprise one or more of: instructor certification information; an instructor experience score; an instructor skill score; instructor professional score in a subject of the generated content; and instructor review scores from another AI system user.

Another embodiment is evidenced by an apparatus for generating content from an artificial intelligence (AI) system, trained by one or more training instructors using training content having one or more training content pieces, comprising. In one embodiment, the apparatus comprises: a processor; a memory, communicatively coupled to the processor, the memory storing processor instructions comprising processor instructions for: accepting first information associating a piece of training content with training content attributes; accepting second information associating the AI system with training instructor profiles; generating the content in response to an AI content generation request from a user; and providing the generated content, the first information and the second information to the user.

Implementations may include one or more of the following features.

Any of the above apparatuses, wherein: the first information and the second information is signed by the AI system.

Any of the above apparatuses, wherein: the processor instructions further comprise processor instructions for: generating third information, the third information comprising evaluated AI generated content including an AI generated content assessment and an AI system authentication of the AI generated content; and generating user authenticated AI generated content including the AI generated content, the third information, and a user score.

Any of the above apparatuses, wherein: the assessment includes a user evaluation score and a trustworthiness score; and the user authenticated AI generated content is signed by the user.

Any of the above apparatuses, wherein: the user authenticated AI generated content is provided as a training input to the generation of second generated AI content.

Any of the above apparatuses, wherein: the first information comprises one of more of: a binary indication of whether the training content is digitally signed by the author of the training content; an author approval score, provided by the author of the training content, the author approval score indicating a measure of the approval of the training content by the author of the training content; a contributor allocation score, the contributor allocation score indicating a proportion of contributor content used in the generation of the training content; and an AI signature with an authenticated instructor profile.

Any of the above apparatuses, wherein: the contributor allocation score includes at least one of: human authored contributor content; approved AI authored contributor content; unapproved AI authored contributor content; and mixed approved AI, unapproved AI, and human authored contributor content.

Any of the above apparatuses, wherein: the training instructor profiles comprise aggregate training instructor profiles which comprise at least one of: a distribution of the training of two or more of the training instructors; a distribution of experience or skill scores of two or more of the training instructors in a subject of the training content; a distribution of review scores of the training instructors, each review score based on an assessment by another of the trustworthiness of the generated content and approval of the generated content.

Another embodiment is evidenced by an apparatus for generating content from an artificial intelligence (AI) system, trained by one or more training instructors using training content having one or more training content pieces. In one embodiment, the apparatus comprises: a training input classification module, for accepting first information associating a piece of training content with training content attributes according to a content classification profile; training instructor profiles having second information associating the AI system with training instructor attributes; an AI system core, for generating the content in response to an AI content generation request from a user; and an AI content evaluation module, for generating an evaluation of the content according to a content evaluation profile having the first information and the second information and for providing the generated content and the evaluation to the user.

The foregoing description of the preferred embodiment has been presented for the purposes of illustration and description. It is not intended to be exhaustive or to limit the disclosure to the precise form disclosed. Many modifications and variations are possible in light of the above teaching. It is intended that the scope of rights be limited not by this detailed description, but rather by the claims appended hereto.

What is claimed is:

1. A method of generating AI generated content from an artificial intelligence (AI) system, trained by one or more training instructors using training content having one or more training content pieces, the method comprising:
accepting first information associating training content with training content attributes;
accepting second information associating the AI system with training instructor profiles;
generating the AI generated content in response to an AI content generation request from a user;
providing the AI generated content, the first information and the second information to the user.

2. The method of claim 1, wherein the first information and the second information is signed by the AI system.

3. The method of claim 2, further comprising:
generating third information, the third information comprising evaluated AI generated content including an AI generated content assessment and an AI system authentication of the AI generated content; and
generating user authenticated AI generated content including the AI generated content, the third information, and a user score.

4. The method of claim 3, wherein the assessment includes an evaluation score and a trustworthiness score signed by the AI system.

5. The method of claim 4, wherein the user authenticated AI generated content is signed by the user.

6. The method of claim 5, wherein the user authenticated AI generated content is provided as a training input to the generation of second generated AI content.

7. The method of claim 1, wherein the first information comprises one of more of:
a binary indication of whether the training content is digitally signed by the author of the training content;
an author approval score, provided by the author of the training content, the author approval score indicating a measure of the approval of the training content by the author of the training content;
a contributor allocation score, the contributor allocation score indicating a proportion of contributor content used in the generation of the training content; and
an AI signature with an authenticated instructor profile.

8. The method of claim 7, wherein the first information includes a signature of an author of the training content.

9. The method of claim 7, wherein the contributor allocation score includes at least one of:
human authored contributor content;
approved AI authored contributor content;
unapproved AI authored contributor content; and
mixed approved AI, unapproved AI, and human authored contributor content.

10. The method of claim 7, wherein the training instructor profiles comprise aggregate training instructor profiles comprising at least one of:
a distribution of the training of two or more of the training instructors;
a distribution of experience or skill scores of two or more of the training instructors in a subject of the training content;
a distribution of review scores of the training instructors, each review score based on an assessment by another of the trustworthiness of the generated content and approval of the generated content.

11. The method of claim 10, wherein training instructor profiles comprise individual profiles of the one or more instructors, which comprise one or more of:
instructor certification information;
an instructor experience score;
an instructor skill score;
instructor professional score in a subject of the generated content; and
instructor review scores from another AI system user.

12. An apparatus for generating content from an artificial intelligence (AI) system, trained by one or more training instructors using training content having one or more training content pieces, comprising:
a processor;
a memory, communicatively coupled to the processor, the memory storing processor instructions comprising processor instructions for:
accepting first information associating a piece of training content with training content attributes;
accepting second information associating the AI system with training instructor profiles;
generating the content in response to an AI content generation request from a user; and
providing the generated content, the first information and the second information to the user.

13. The apparatus of claim 12, wherein the first information and the second information is signed by the AI system.

14. The apparatus of claim 13, wherein the processor instructions further comprise processor instructions for:
generating third information, the third information comprising evaluated AI generated content including an AI generated content assessment and an AI system authentication of the AI generated content; and
generating user authenticated AI generated content including the AI generated content, the third information, and a user score.

15. The apparatus of claim 14, wherein:
the assessment includes a user evaluation score and a trustworthiness score; and
user authenticated AI generated content is signed by the user.

16. The apparatus of claim 15, wherein the user authenticated AI generated content is provided as a training input to the generation of second generated AI content.

17. The apparatus of claim 12, wherein the first information comprises one of more of:
a binary indication of whether the training content is digitally signed by the author of the training content;
an author approval score, provided by the author of the training content, the author approval score indicating a measure of the approval of the training content by the author of the training content;
a contributor allocation score, the contributor allocation score indicating a proportion of contributor content used in the generation of the training content; and
an AI signature with an authenticated instructor profile.

18. The apparatus of claim 17, wherein the contributor allocation score includes at least one of:
human authored contributor content;
approved AI authored contributor content;
unapproved AI authored contributor content; and
mixed approved AI, unapproved AI, and human authored contributor content.

19. The apparatus of claim 12, wherein the training instructor profiles comprise aggregate training instructor profiles which comprise at least one of:
a distribution of the training of two or more of the training instructors;
a distribution of experience or skill scores of two or more of the training instructors in a subject of the training content;
a distribution of review scores of the training instructors, each review score based on an assessment by another of the trustworthiness of the generated content and approval of the generated content.

20. An apparatus for generating content from an artificial intelligence (AI) system, trained by one or more training instructors using training content having one or more training content pieces, comprising:
a training input classification module, for accepting first information associating a piece of training content with training content attributes according to a content classification profile;
training instructor profiles having second information associating the AI system with training instructor attributes;
an AI system core, for generating the content in response to an AI content generation request from a user; and
an AI content evaluation module, for generating an evaluation of the content according to a content evaluation profile having the first information and the second information and for providing the generated content and the evaluation to the user.
